(19) United States
(12) Patent Application Publication
(10) Pub. No.: US 2013/0065697 A1
(43) Pub. Date: Mar. 14, 2013

(54) ROTATING SHAFT STRUCTURE

(71) Applicants: AN SZU HSU, NEW TAIPEI CITY (TW); CHIEN NAN TSAI, NEW TAIPEI CITY (TW)

(72) Inventors: AN SZU HSU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/228,646

(22) Filed: Sep. 9, 2011

(51) Int. Cl. F16C 3/00

(52) U.S. Cl. 464/179

(57) ABSTRACT

A rotating shaft structure with rotational and positioning functions includes an assembly of a rotating shaft and a bridge connector. The bridge connector includes a pivotal portion formed as a type of geometry section to define a space or slotted chamber to pivot the rotating shaft. The bridge connector is defined with a flange portion connected to the pivotal portion and including a bolt hole. A fastener is assembled to the bolt hole of the flange portion of the bridge connector to allow the rotating shaft of being rotated or stopped to be positioned in the space or slotted chamber defined by the pivotal portion of the bridge connector. Conditions such as inferior rotation and positioning effects of the conventional structure applied to the high-torque rotating shaft device can be improved.

### BACKGROUND OF THE INVENTION

Field of the Invention

The present invention relates to a rotating shaft structure for an electronic device, and in particular relates to an assembly of a rotating shaft and a bridge connector capable of generating rotational and positioning functions in the operating and positioning processes.

Description of the Related Art

Electronic devices, such as mobile phones, notebook computers, personal digital assistants (PDAs), digital cameras and E-books, are conventionally provided with pivotal shafts or rotating shafts, capable of being reciprocally rotated by an external force to open or close a cover, a display monitor or a viewing window thereof. These pivotal shafts or rotating shafts are usually assembled with components formed with holes thereon, such as washers, friction plates and elastic elements, and fasteners are fixed at two ends of the rotating shaft to prevent the washers, friction plates and elastic elements from axial displacement, so that a rotating shaft structure provided with axial packing is formed. In conventional arts, a pivotal shaft or rotating shafts capable of being immediately positioned after rotation is disclosed.

One topic related to operation, movement and structural design of the case above is that embedded structures such as positioning flanges, concaves or concave-convex positioning portions are disposed on washers, friction plates or the related components, so that a positioning function is formed when the rotating flange is located at the concave in the rotating operation of the rotating shaft. As known by those who skilled in the arts, when these positioning flanges, concaves or concave-convex positioning portions applied in large-torque or large electronic products are suffered for a long time operation, the imperfect conditions such as regular abrasions and unsuitable positioning effects are occurred thereon.

Another topic related to the structural design of the pivotal shaft or rotating shaft is that a combination of washers and friction plates applied in the prior arts is incorporated with elastic rings or springs to store or release energy, to attain the rotating and positioning functions of the rotating shaft or pivotal shaft. However, the structural design and assembly installations of this conventional art are more complicated and cannot meet the actual requirements.

These representative reference data above disclose the conditions of operative and structural designs related to the rotating shafts or the related components. Actually, the rotating shafts or the related components and the applications applied in the prior arts still can be redesigned to reduce the complications of the structures and assembly installations and to increase the operation stability and serviceability of the high-torque or large-sized electronic products by altering the type of use, but a further improvement is not physically taught or disclosed in these reference data.

### BRIEF SUMMARY OF THE INVENTION

In view of this, the main purpose of the present invention is to provide a rotating shaft structure with rotational and positioning functions. The rotating shaft structure of the present invention includes an assembly of a rotating shaft and a bridge connector. The bridge connector includes a pivotal portion formed as a type of geometry section to define a space or slotted chamber to pivot the rotating shaft. The bridge connector is defined with a flange portion connected to the pivotal portion and including a bolt hole. A fastener is assembled to the bolt hole of the flange portion of the bridge connector to allow the rotating shaft of being rotated or stopped to be positioned in the space or slotted chamber defined by the pivotal portion of the bridge connector. Conditions such as inferior rotation and positioning effects of the conventional structure applied to the high-torque rotating shaft device can be improved.

According to the rotating shaft structure of the present invention, the flange portion disposed at a position parallel to a horizontal reference axis to form a type of correspondence is connected to two ends of the pivotal portion, so that the fastener passed through the bolt hole of the flange portion is utilized to adjust the loose-tight degree in between the pivotal portion and the rotating shaft.

According to the rotating shaft structure of the present invention, the fastener is provided with an elastic element, so that the bridge connector and the pivotal portion thereof can have an elastic vibration range to absorptively prevent the rotating shaft from being damaged by other external forces or mechanical vibrations.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an outside view showing an assembly of a rotating shaft and a bridge connector of an embodiment of the present invention;

FIG. 2 is a schematic exploded view of the structure in FIG. 1;

FIG. 3 is a schematic sectional view showing the assembled structure of a bridge connector, a fastener and a rotating shaft in FIG. 1;

FIG. 4 is a schematic outside view showing a modified embodiment of the present invention;

FIG. 5 is a schematic exploded view of the structure in FIG. 4;

FIG. 6 is a schematic sectional view showing the assembled structure of a bridge connector, a fastener and a rotating shaft in FIG. 4.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

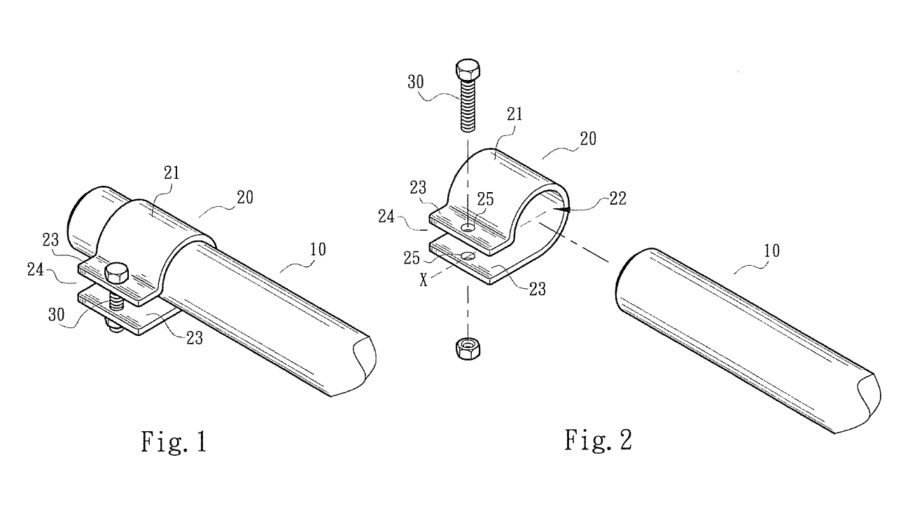

Referring to FIGS. 1, 2 and 3, a rotating shaft structure of the present invention comprises an assembly of a rotating shaft 10 and a bridge connector 20. The rotating shaft 10 is selected of a type of pillar body, capable of being fixed assembled to or attached on an electronic device (not shown in FIGS.). The bridge connector 20, made of elastic or non-elastic material, is selected of an integrally-formed structural type. In the preferred embodiment, the bridge connector 20 comprises a pivotal portion 21 formed as a type of geometry section and defining an inner space or a slotted chamber 22 to pivot the rotating shaft 10.

As shown in these figures, the pivotal portion 21 of the bridge connector 20 has a sectional outline surroundingly formed of a type of similar annularity. The bridge connector 20 is defined with a flange portion 23 and an opening 24 commonly defined by the flange portion 23, wherein the flange portion 23 including a bolt hole 25 thereon is connected to the two ends of the pivotal portion 21. In the adopted embodiment, the flange portion 23 is disposed at a position parallel to a horizontal reference axis “x” to form a type of correspondence. A fastener 30 is assembled to the bolt hole 25 of the flange portion 23 of the bridge connector 20, to adjust the loose-tight degree in between the pivotal portion 21 and the rotating shaft 10 and to allow the rotating shaft 10 of being rotated or stopped to be positioned in the space or slotted chamber 22 defined by the pivotal portion 21 of the bridge connector 20. In the adopted embodiment, the fastener 30 is selected of a type of bolt.

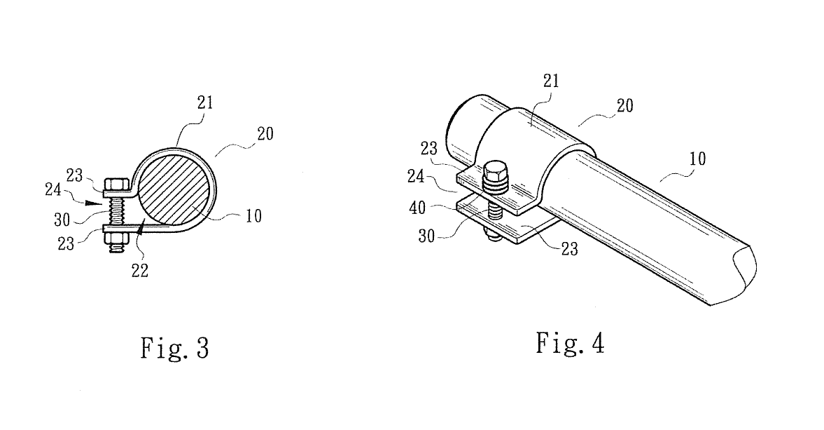

Referring to FIG. 3, when the rotating shaft 10 is assembled in the space or slotted chamber 22 defined by the pivotal portion 21 of the bridge connector 20, the fastener 30 passed through the bolt hole 25 of the flange portion 23 is utilized to adjust the loose-tight degree in between the pivotal portion 21 and the rotating shaft 10 and the clearance of the opening 24.

Two design considerations provided in the allocation type of the bridge connector 20 and the rotating shaft 10 are required to explain as below.

Firstly, with the allocation mechanism of the bridge connector 20 and the fastener 30 capable of being adjusted in accordance with the torque or acting force required by the electronic products, the bridge connector 20 and the rotating shaft 10 are particularly intended for a high-torque required or large-sized electronic products. With the structural type of the bridge connector 20, the fastener 30 can have an allowance sufficient to adjust the loose-tight degree of the pivotal portion 21 of the bridge connector 20 and the rotating shaft 10 and the clearance of the corresponding flange portions 23 for satisfying the actual requirement of the rotating shaft 10. With the adjustment of the loose-tight degree of between the pivotal portion 21 of the bridge connector 20 and the rotating shaft 10, the rotating shaft 10 can be immediately positioned after the rotating shaft 10 is rotated, such that the conditions such as inferior rotation and positioning effects of the conventional structure applied to the high-torque rotating shaft device can be improved.

Secondly, the allocation mechanism of between the bridge connector 20 (or the flange portion 23) and the fastener 30, particularly illustrated in FIG. 3, can allow a clearance to be formed between the space or slotted chamber 22 defined by the pivotal portion 21 of the bridge connector 20 and the rotating shaft 10 to assemble with the rotating shafts 10 of different sizes or specifications. That is, the rotating shafts 10 of different diameters or sizes are allowable to be assembled in the inner space or slotted chamber 22 defined by the pivotal portion 21 of the bridge connector 20, and the loose-tight degree and the rotational/positioning functions of the assembly of the bridge connector 20 and the rotating shaft 10 can be adjusted by the fastener 30.

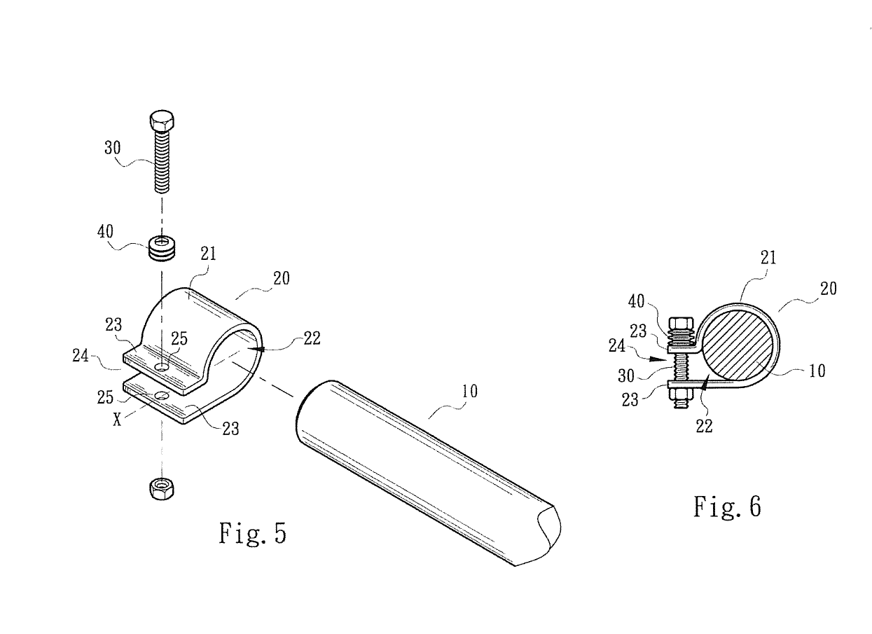

Referring to FIGS. 4, 5 and 6, a modified embodiment of the present invention is illustrated, comprising the rotating shaft 10, the bridge connector 20, and at least one fastener 30 provided with an elastic element 40. In the adopted embodiment, the elastic element 40 is selected of a type of helical spring. The elastic element 40 is pressed on the bolt hole 25 of the flange portion 23 of the bridge connector 20. The elastic element 40 is pressed on the flange portion 23 located at an upper side of the bridge connector 20. With the fastener 30 provided with the elastic element 40, it is understood that the bridge connector 20 and the pivotal portion 21 thereof can have an elastic vibration range to absorptively prevent the rotating shaft 10 from being damaged by other external forces or mechanical vibrations.

In comparison with the conventional skills, the rotating shaft structure of the present invention provided with the conditions of operative rotation and positioning function is representatively characterized with the considerations and advantages as follows.

Firstly, with the rotating shaft 10 and the structures of the related components (e.g., the space or slotted chamber 22 defined by the pivotal portion 21 of the bridge connector 20, the flange portions 23, and the fastener 30) of the present invention, it is obviously that the structural features of the present invention are much different from those of washers and friction plates applied in the prior arts, and the imperfect conditions such as regular abrasions and unsuitable positioning effects occurred at the embedded structures of the positioning flanges, the concaves or the concave-convex positioning portions applied on the conventional components for a long-term operation can be also improved.

Secondly, with the allocation structure of the rotating shaft 10, the bridge connector 20 and the fastener 30 of the present invention, the design for the overall structure of washers and friction plates and the complicated assembly installations applied in the prior arts can be simplified.

Thirdly, with the partial allocation structures from the bridge connector 20, the space or slotted chamber 22 defined by the pivotal portion 21, the flange portion 23 and the fastener 30, or the elastic element 40 of the present invention, it is simple and convenient for an operator to perform a locking process of the fastener 30 to directly or indirectly produce an interlocking mechanism to the pivotal portion 21 of the bridge connector 20 or the flange portion 23, to cause the bridge connector 20 to form a clamping function to the rotating shaft 10.

In summary, the present invention provides an effective rotating shaft structure with a spatial arrangement and advantages superior to the conventional arts. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A rotating shaft structure, comprising:
an assembly of a rotating shaft and a bridge connector, the bridge connector comprising a pivotal portion formed as a type of geometry section to define a space or slotted chamber to pivot the rotating shaft, the bridge connector defining with an opening and a flange portion connected to the pivotal portion and including a bolt hole; and
a fastener assembled to the bolt hole of the flange portion of the bridge connector to allow the rotating shaft of being rotated or stopped to be positioned in the space or slotted chamber defined by the pivotal portion of the bridge connector.

2. The rotating shaft structure as claimed in claim 1, wherein the pivotal portion of the bridge connector has a sectional outline surroundingly formed of a type of similar annularity.

3. The rotating shaft structure as claimed in claim 1, wherein the flange portion of the bridge connector is connected to two ends of the pivotal portion, disposed at a position parallel to a horizontal reference axis to form a type of correspondence and commonly define the opening.

4. The rotating shaft structure as claimed in claim 2, wherein the flange portion of the bridge connector is connected to two ends of the pivotal portion, disposed at a position parallel to a horizontal reference axis to form a type of correspondence and commonly define the opening.

5. The rotating shaft structure as claimed in claim 1, wherein the fastener is provided with an elastic element.

6. The rotating shaft structure as claimed in claim 5, wherein the elastic element is pressed on the bolt hole of the flange portion of the bridge connector.

7. The rotating shaft structure as claimed in claim 5, wherein the elastic element is pressed on the flange portion located at an upper side of the bridge

8. The rotating shaft structure as claimed in claim 5, wherein the elastic element is selected of a type of helical spring.

9. The rotating shaft structure as claimed in claim 6, wherein the elastic element is selected of a type of helical spring.

10. The rotating shaft structure as claimed in claim 7, wherein the elastic element is selected of a type of helical spring.

11. The rotating shaft structure as claimed in claim 1, wherein the rotating shaft is selected of a type of pillar body.

12. The rotating shaft structure as claimed in claim 1, wherein the fastener is selected of a type of bolt.

13. The rotating shaft structure as claimed in claim 1, wherein the bridge connector made of an elastic material is selected of an integrally-formed structural type.

14. The rotating shaft structure as claimed in claim 1, wherein the bridge connector made of a non-elastic material is selected of an integrally-formed structural type.

15. The rotating shaft structure as claimed in claim 1, wherein the rotating shaft is attached on an electronic device.

16. A rotating shaft structure, comprising:
a bridge connector, comprising a pivotal portion formed as a type of geometry section to define a space or slotted chamber and defining with an opening and a flange portion connected to the pivotal portion and including a bolt hole; and
a fastener assembled to the bolt hole of the flange portion of the bridge connector.

17. The rotating shaft structure as claimed in claim 16, wherein the pivotal portion of the bridge connector has a sectional outline surroundingly formed of a type of similar annularity.

18. The rotating shaft structure as claimed in claim 16, wherein the flange portion of the bridge connector is connected to two ends of the pivotal portion, disposed at a position parallel to a horizontal reference axis to form a type of correspondence, and commonly define the opening.

19. The rotating shaft structure as claimed in claim 17, wherein the flange portion of the bridge connector is connected to two ends of the pivotal portion, disposed at a position parallel to a horizontal reference axis to form a type of correspondence, and commonly define the opening.

20. The rotating shaft structure as claimed in claim 16, wherein the fastener is provided with an elastic element.

21. The rotating shaft structure as claimed in claim 20, wherein the elastic element is pressed on the bolt hole of the flange portion of the bridge connector.

22. The rotating shaft structure as claimed in claim 20, wherein the elastic element is pressed on the flange portion located at an upper of the bridge connector.

23. The rotating shaft structure as claimed in claim 20, wherein the elastic element is selected of a type of helical spring.

24. The rotating shaft structure as claimed in claim 21, wherein the elastic element is selected of a type of helical spring.

25. The rotating shaft structure as claimed in claim 22, wherein the elastic element is selected of a type of helical spring.

26. The rotating shaft structure as claimed in claim 16, wherein the fastener is selected of a type of bolt.

27. The rotating shaft structure as claimed in claim 16, wherein the bridge connector made of an elastic material is selected of an integrally-formed structural type.

28. The rotating shaft structure as claimed in claim 16, wherein the bridge connector made of a non-elastic material is selected of an integrally-formed structural type.
